(19) United States
(12) Patent Application Publication
(10) Pub. No.: US 2026/0113649 A1
(43) Pub. Date: Apr. 23, 2026

(54) PREDICTION SYSTEM TO PREDICT OCCURRENCE OF POSITIONING ABNORMALITY, AND METHOD TO PREDICT OCCURRENCE OF POSITIONING ABNORMALITY

(71) Applicant: Kubota Corporation, Osaka (JP)

(72) Inventors: Akira CHABATA, Sakai-shi (JP); Koji KATO, Sakai-shi (JP); Toshinobu NAGAMATSU, Sakai-shi (JP)

(21) Appl. No.: 19/360,051

(22) Filed: Oct. 16, 2025

(30) Foreign Application Priority Data
Oct. 17, 2024 (JP) 2024-181533

(51) Int. Cl. H04W 24/08; H04W 64/00

(52) U.S. Cl. CPC H04W 24/08; H04W 64/00

(57) ABSTRACT

A prediction system includes a plurality of base stations to receive base station reception information from a satellite, a first calculator configured or programmed to derive base station error information for each of the plurality of base stations based on the base station reception information for each of the plurality of base stations and base station coordinates for each of the plurality of base stations, a storage to store a variation characteristic indicating a relationship between a first change amount, which is a change amount of the base station error information accompanied by a lapse of time, and an occurrence of a positioning abnormality at a predetermined position, and a second calculator configured or programmed to derive predicted abnormality information to predict an occurrence of the positioning abnormality based on the base station error information and the variation characteristic.

### CROSS REFERENCE TO RELATED APPLICATIONS

This application claims the benefit of priority to Japanese Patent Application No. 2024-181533 filed on Oct. 17, 2024. The entire contents of this application are hereby incorporated herein by reference.

### BACKGROUND OF THE INVENTION

### 1. Field of the Invention

The present disclosure relates to prediction systems to predict an occurrence of a positioning abnormality and methods to predict an occurrence of a positioning abnormality.

### 2. Description of the Related Art

Global navigation satellite system (GNSS) positioning is widely used as a method of positioning a position of a mobile station such as an agricultural machine or a construction machine. In the GNSS positioning, due to the influence of error information such as an ionospheric error and a tropospheric error, a deviation (hereinafter, sometimes referred to as a “positioning abnormality”) exceeding an allowable range may occur between the actual position of the mobile station and the positioning information derived by the GNSS positioning.

Japanese Laid-Open Patent Publication No. 2018-105708 discloses a work vehicle including a constituent device for automatic traveling of a mobile station such as an agricultural machine or a construction machine using RTK-GNSS positioning. In automatic traveling of a mobile station such as an agricultural machine or a construction machine, highly accurate positioning information of the mobile station is required for ensuring safety of a worksite such as a farm field or a construction site. When a positioning abnormality occurs, the accuracy of the positioning information decreases, and thus it may be difficult to ensure the safety of the worksite in the automatic traveling of the mobile station. Thus, in a case where a positioning abnormality occurs, the automatic traveling of the mobile station is stopped to ensure the safety of the worksite.

As a technique for determining a positioning abnormality, for example, WO 2020/066155 A discloses an information processing device that calculates a positioning accuracy index to be an index of reliability of a positioning result based on a degree of variation according to a variation in a predetermined period of a parameter including an ionospheric error, a tropospheric error, and the like.

### SUMMARY OF THE INVENTION

According to the technique described in WO 2020/066155 A, it is possible to determine whether or not a positioning abnormality occurs at the time of positioning based on the positioning accuracy index. Thus, in the information processing device of WO 2020/066155 A, when it is determined that the positioning abnormality has occurred, it is possible to ensure the safety of the worksite by stopping the automatic traveling of the mobile station. On the other hand, the stopping of automatic traveling of the mobile station causes a decrease in work efficiency in the worksite.

Due to the occurrence of the positioning abnormality, the time until the positioning abnormality is resolved and the automatic traveling is resumed after the automatic traveling of the mobile station is stopped may be prolonged. As a means to continue the automatic traveling of the mobile station after the occurrence of the positioning abnormality, for example, switching of a base station as a transmission source of correction information received by the mobile station, a change from GNSS positioning to position identification by dead reckoning, and the like are known. Here, transition to the means to continue the automatic traveling may take time.

The technique described in WO 2020/066155 A determines whether or not a positioning abnormality occurs at the time of positioning, and cannot predict the occurrence of positioning abnormality. Therefore, in the technique described in WO 2020/066155 A, when a positioning abnormality occurs, it takes time to shift to the above-described means to continue the automatic traveling of the mobile station, and the restart of the automatic traveling of the mobile station may be delayed.

Example embodiments of the present invention provide prediction systems each capable of predicting an occurrence of positioning abnormality, and methods to predict an occurrence of positioning abnormality.

A prediction system according to an example embodiment of the present disclosure includes a plurality of base stations to receive base station reception information from a satellite, a first calculator configured or programmed to derive base station error information for each of the plurality of base stations based on the base station reception information for each of the plurality of base stations and base station coordinates for each of the plurality of base stations, a storage to store a variation characteristic indicating a relationship between a first change amount, which is a change amount of the base station error information accompanied by a lapse of time, and an occurrence of a positioning abnormality at a predetermined position, and a second calculator configured or programmed to derive predicted abnormality information to predict an occurrence of the positioning abnormality based on the base station error information and the variation characteristic.

Further, a method to predict an occurrence of positioning abnormality according to another example embodiment of the present disclosure includes a first reception step of receiving base station reception information from a satellite in a plurality of base stations, an error information deriving step of deriving base station error information for each of the plurality of base stations based on the base station reception information for each of the plurality of base stations and base station coordinates for each of the plurality of base stations, and a prediction step of predicting an occurrence of the positioning abnormality based on a variation characteristic indicating a relationship between a first change amount, which is a change amount of the base station error information accompanied by a lapse of time, and an occurrence of a positioning abnormality at a predetermined position.

According to example embodiments of the present disclosure, it is possible to provide prediction systems each capable of predicting an occurrence of positioning abnormality and methods to predict an occurrence of positioning abnormality.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram illustrating an overall configuration of a prediction system according to a first example embodiment of the present invention.

FIG. 2 is a conceptual diagram of derivation of positioning information.

FIG. 3 is a conceptual diagram of derivation of error information.

FIG. 4 is a conceptual diagram of derivation of predicted abnormality information and predicted base station information.

FIGS. 5A to 5C are explanatory diagrams for describing a first case of deriving the predicted abnormality information.

FIGS. 6A to 6D are explanatory diagrams for describing a variation characteristic used to derive the predicted abnormality information that a positioning abnormality will occur in FIG. 5C.

FIG. 7 is an explanatory diagram for describing a second case of deriving the predicted abnormality information.

FIGS. 8A to 8C are explanatory diagrams for describing a third case of deriving the predicted abnormality information.

FIGS. 9A to 9C are explanatory diagrams for describing a variation characteristic used when the predicted abnormality information that a positioning abnormality will occur is derived in FIG. 8B.

FIGS. 10A to 10C are explanatory diagrams for describing a variation characteristic used when the predicted abnormality information that a positioning abnormality will occur is not derived in FIG. 8B.

FIGS. 11A to 11C are explanatory diagrams for describing a derivation case of the predicted base station information.

FIG. 12 is a flowchart illustrating a flow of processing by the prediction system according to the first example embodiment of the present invention.

FIG. 13 is a schematic diagram illustrating an overall configuration of a prediction system according to a second example embodiment of the present invention.

FIG. 14 is a flowchart illustrating a flow of prediction of an occurrence of positioning abnormality by the prediction system according to the second example embodiment of the present invention.

FIG. 15 illustrates a modification of the flowchart illustrated in FIG. 12.

### DETAILED DESCRIPTION OF THE EXAMPLE EMBODIMENTS

Hereinafter, an outline of example embodiments of the present disclosure will be listed and described.
(1) A prediction system according to the present example embodiment includes a plurality of base stations to receive base station reception information from a satellite, a first calculator configured or programmed to derive base station error information for each of the plurality of base stations based on the base station reception information for each of the plurality of base stations and base station coordinates for each of the plurality of base stations, a storage to store a variation characteristic indicating a relationship between a first change amount, which is a change amount of the base station error information accompanied by a lapse of time, and an occurrence of a positioning abnormality at a predetermined position, and a second calculator configured or programmed to derive predicted abnormality information to predict an occurrence of the positioning abnormality based on the base station error information and the variation characteristic.

According to the prediction system of the present example embodiment, it is possible to derive predicted abnormality information to predict an occurrence of a positioning abnormality at a predetermined position.
(2) In the prediction system of (1) described above, the base station reception information may include at least a pseudo-distance and a carrier phase.
(3) In the prediction system of (1) or (2) described above, the base station error information may include at least one of an ionospheric delay error or a tropospheric delay error in the plurality of base stations.
(4) In the prediction system according to any one of (1) to (3) described above, the variation characteristic may include a past record indicating a relationship between information of the first change amount at a base station position of each of the plurality of base stations and an occurrence of the positioning abnormality in a predetermined period and a predetermined time zone.

According to the prediction system of any one of (2) to (4) described above, the prediction accuracy of the occurrence of the positioning abnormality at the predetermined position is improved.
(5) In the prediction system according to any one of (1) to (4), described above, the second calculator may be configured or programmed to derive predicted abnormality information that the positioning abnormality will occur when a base station position of the base station in which the first change amount exceeds a predetermined reference approaches the predetermined position.

According to the prediction system of (5) described above, the prediction accuracy of the occurrence of the positioning abnormality at the predetermined position is further improved.
(6) The prediction system according to any one of (1) to (4) described above may include a mobile station to receive mobile station reception information from a satellite, a third calculator configured or programmed to derive positioning information of the mobile station based on the base station reception information and the mobile station reception information, in which the predetermined position may be the positioning information, the first calculator may be configured or programmed to derive the base station error information and mobile station error information of the mobile station based on the base station reception information, the base station coordinates, the mobile station reception information, and the positioning information, the variation characteristic may indicate a relationship among the first change amount, a second change amount that is a change amount of the mobile station error information accompanied by a lapse of time, and an occurrence of a positioning abnormality in the positioning information, and the second calculator may be configured or programmed to derive the predicted abnormality information based on the base station error information, the mobile station error information, and the variation characteristic.

According to the prediction system of (6) described above, it is possible to derive predicted abnormality information to predict an occurrence of a positioning abnormality in a mobile station such as an agricultural machine or a construction machine.
(7) In the prediction system (6) described above, the mobile station reception information may include at least a pseudo-distance and a carrier phase.

According to the prediction system of (7) described above, the prediction accuracy of the occurrence of the positioning abnormality in the mobile station is improved.
(8) The prediction system of (7) described above may include a fourth calculator configured or programmed to derive RTK correction information based on the base station reception information, in which the third calculator may derive the positioning information based on the RTK correction information and the mobile station reception information.

According to the prediction system (8) described above, the accuracy of the positioning information of the mobile station is improved.
(9) In the prediction system according to any one of (6) to (8) described above, the mobile station error information may include at least one of an ionospheric delay error or a tropospheric delay error in the mobile station.

According to the prediction system of (9) described above, the prediction accuracy of the occurrence of the positioning abnormality in the mobile station is further improved.
(10) In the prediction system according to any one of (6) to (9) described above, the second calculator may derive predicted abnormality information that the positioning abnormality will occur when a difference between the first change amount of any one of the plurality of base stations and the second change amount exceeds a predetermined reference.

According to the prediction system of (10) described above, the prediction accuracy of the occurrence of the positioning abnormality in the mobile station is further improved.
(11) The prediction system of any one of (6) to (10) described above may include a fifth calculator configured or programmed to derive predicted base station information to predict the base station having the base station error information having a small difference from the mobile station error information based on the base station error information, the mobile station error information, and the variation characteristic.

According to the prediction system of (11) described above, the base station to be switched can be set before the occurrence of the positioning abnormality by the predicted base station information. Thus, it is possible to smoothly switch the base station when a positioning abnormality occurs.
(12) In the prediction system of (11) described above, the third calculator may be configured or programmed to derive the positioning information based on the base station reception information of the base station predicted by the predicted base station information and the mobile station reception information.

According to the prediction system of (12) described above, continuous automatic traveling of the mobile station becomes possible, and work efficiency in the worksite is improved.
(13) In the prediction system according to any one of (6) to (10) described above, the mobile station may include a sixth calculator configured or programmed to identify a position of the mobile station by dead reckoning.

According to the prediction system of (13) described above, it is possible to identify the position of the mobile station by dead reckoning when a positioning abnormality occurs. Thus, continuous automatic traveling of the mobile station becomes possible, and work efficiency in the worksite is improved.
(14) A method to predict an occurrence of positioning abnormality according to another example embodiment includes a first reception step of receiving base station reception information from a satellite in a plurality of base stations, an error information deriving step of deriving base station error information for each of the plurality of base stations based on the base station reception information for each of the plurality of base stations and base station coordinates for each of the plurality of base stations, and a prediction step of predicting an occurrence of the positioning abnormality based on a variation characteristic indicating a relationship between a first change amount, which is a change amount of the base station error information accompanied by a lapse of time, and an occurrence of a positioning abnormality at a predetermined position.

According to the method to predict the occurrence of positioning abnormality according to another example embodiment, the occurrence of positioning abnormality at a predetermined position can be predicted.

(15) The method to predict an occurrence of a positioning abnormality described above in (14) may include a second reception step of receiving mobile station reception information from a satellite in a mobile station, a positioning step of deriving positioning information of the mobile station based on the base station reception information and the mobile station reception information, in which the predetermined position may be the positioning information, the error information deriving step may be a step of deriving the base station error information and mobile station error information of the mobile station based on the base station reception information, the base station coordinates, the mobile station reception information, and the positioning information, the variation characteristic may indicate a relationship among the first change amount, a second change amount that is a change amount of the mobile station error information accompanied by a lapse of time, and an occurrence of a positioning abnormality in the positioning information, and the prediction step may include predicting an occurrence of the positioning abnormality based on the base station error information, the mobile station reception information, and the variation characteristic.

According to the method to predict an occurrence of a positioning abnormality described in (15) described above, an occurrence of a positioning abnormality in a mobile station such as an agricultural machine or a construction machine can be predicted.

Hereinafter, example embodiments of the present disclosure will be described in detail with reference to the drawings. Note that at least some of the example embodiments described below may be arbitrarily combined.

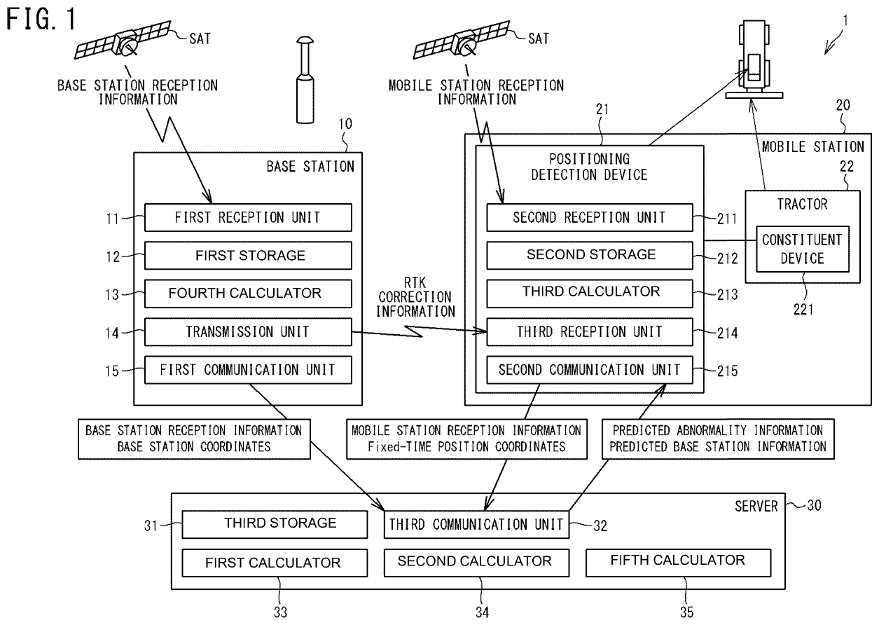

FIG. 1 is a schematic diagram illustrating an overall configuration of a prediction system 1 according to a first example embodiment of the present disclosure. The prediction system 1 includes a plurality of base stations 10, a mobile station 20, and a server 30. Note that each of the plurality of base stations 10 has a similar configuration. Thus, in FIG. 1, one of the plurality of base stations 10 is illustrated, and the other base stations 10 are omitted. The mobile station 20 of the present example embodiment is a tractor 22 including a positioning detection device 21. The tractor 22 is an example of a work vehicle, and the present disclosure is not limited to the tractor 22, and may be other work vehicles such as agricultural machines, construction machines, and utility vehicles.

The base station 10 includes a first reception unit 11, a first storage 12, a fourth calculator 13, a transmission unit 14, and a first communication unit 15. The base station 10 is a fixed base station fixed at a predetermined position. The first reception unit 11 has a reception function to receive base station reception information from a satellite SAT. The first storage 12 has a storage function to store a program or the like to derive RTK correction information based on coordinates (hereinafter, it may be simply referred to as “base station coordinates”) at which the base station 10 is fixed, base station reception information, and base station coordinates. The fourth calculator 13 is configured or programmed to derive the RTK correction information based on the program to derive the RTK correction information. The transmission unit 14 has a transmitting function to transmit the RTK correction information derived by the fourth calculator 13 to the mobile station 20. The first communication unit 15 has a communication function to communicate with the server 30. The first communication unit 15 transmits the base station reception information received by the first reception unit 11 and the information such as the base station coordinates stored in the first storage 12 from the base station 10 to the server 30.

The positioning detection device 21 includes a second reception unit 211, a second storage 212, a third calculator 213, a third reception unit 214, and a second communication unit 215. The second reception unit 211 has a reception function to receive mobile station reception information from the satellite SAT. The second storage 212 has a storage function to store a program to derive positioning information and the like of the mobile station 20, information transmitted from the server 30, and the like. The third calculator 213 is configured or programmed to derive fixed-time position coordinates or the like which is the positioning information of the mobile station 20 based on the above program. The third reception unit 214 has a reception function to receive the RTK correction information transmitted from the transmission unit 14. The second communication unit 215 has a communication function for communicating with the server 30. The second communication unit 215 transmits, from the mobile station 20 to the server 30, the mobile station reception information received by the second reception unit 211 and information such as the fixed-time position coordinates of the mobile station 20 derived by the third calculator 213. In addition, the second communication unit 215 receives information such as predicted abnormality information and predicted base station information to be described later from the server 30 to the mobile station 20. The information such as the predicted abnormality information and the predicted base station information received from the server 30 is stored in the second storage 212.

The tractor 22 is connected to the positioning detection device 21 in a wired or wireless manner. The tractor 22 includes a constituent device 221 for automatic traveling based on the positioning information of the mobile station 20 from the positioning detection device 21. The prediction system 1 derives the positioning information of the mobile station 20 using RTK-GNSS positioning. A work vehicle including a constituent device to perform automatic traveling of a mobile station based on positioning information of the mobile station derived by the RTK-GNSS positioning is known, and is disclosed in, for example, Japanese Laid-Open Patent Publication No. 2018-105708. As the constituent device 221, a constituent device similar to the known work vehicle can be applied. Here, the prediction system of the present disclosure is not limited to a prediction system that derives positioning information of the mobile station 20 using RTK-GNSS positioning. For example, the prediction system of the present disclosure can be a prediction system that derives positioning information of a mobile station using other known positioning methods such as PPP positioning and DGPS positioning. Note that, from the viewpoint of accuracy of the positioning information of the mobile station 20, the prediction system of the present disclosure is preferably a prediction system using RTK-GNSS positioning like the prediction system 1.

The server 30 includes a third storage 31, a third communication unit 32, a first calculator 33, a second calculator 34, and a fifth calculator 35. The third storage 31 has a storage function for storing a program to derive base station error information, mobile station error information, predicted abnormality information, predicted base station information, and the like, variation characteristics, and the like. The first calculator 33 is configured or programmed to derive base station error information of the base station 10 and mobile station error information of the mobile station 20 based on the above program. The second calculator 34 is configured or programmed to derive predicted abnormality information in the mobile station 20 based on the program described above. The fifth calculator 35 is configured or programmed to derive predicted base station information related to a base station to be switched when a positioning abnormality occurs based on the above program. The third communication unit 32 has a communication function for communicating with the base station 10 and the mobile station 20. In the prediction system 1, the third communication unit 32 of the server 30 and the first communication unit 15 of the base station 10 are configured to be able to transmit and receive information to and from each other. Further, the third communication unit 32 of the server 30 and the second communication unit 215 of the positioning detection device 21 in the mobile station 20 are configured to be able to transmit and receive information to and from each other. The third communication unit 32 receives the base station reception information and the information such as the base station coordinates from the base station 10 to the server 30. The third communication unit 32 receives the mobile station reception information and the information such as the fixed-time position coordinates of the mobile station 20 from the mobile station 20 to the server 30. The third communication unit 32 transmits information such as the predicted abnormality information derived by the third calculator 213 and the predicted base station information derived by the fifth calculator 35 from the server 30 to the mobile station 20.

Derivation of various types of information by the first calculator 33, the second calculator 34, the third calculator 213, the fourth calculator 13, and the fifth calculator is executed by a calculator of a computer. In FIG. 1, a calculator corresponding to each piece of information to be derived is illustrated. However, this does not mean that a corresponding calculator exists for each piece of information to be derived. For example, in the prediction system 1, in the server 30, derivation of the base station error information, the predicted abnormality information, and the predicted base station information by the first calculator 33, the second calculator 34, and the fifth calculator 35 is executed by one calculator.

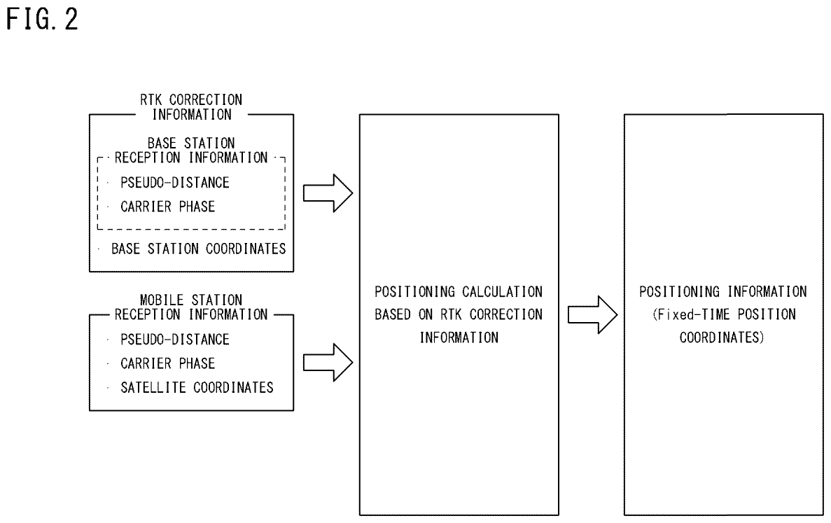

FIG. 2 is a conceptual diagram of derivation of positioning information. The positioning information is derived by the positioning calculation based on the RTK correction information by the third calculator 213 in the positioning detection device 21 of the mobile station 20. The third calculator 213 of the present disclosure is configured or programmed to derive fixed-time position coordinates of the mobile station 20 as the positioning information. In the positioning calculation based on the RTK correction information, the RTK correction information received by the third reception unit 214 and the mobile station reception information received by the second reception unit 211 are used as input information. The RTK correction information used to derive the positioning information includes at least a pseudo-distance and a carrier phase of the base station reception information and base station coordinates. The mobile station reception information used to derive the positioning information includes at least a pseudo-distance and a carrier phase. Note that, in the present disclosure, the positioning information of the mobile station can be derived by positioning calculation similar to positioning calculation used in known RTK-GNSS positioning.

FIG. 2 illustrates a conceptual diagram in which the mobile station reception information includes satellite coordinates. Here, the satellite coordinates used to derive the positioning information can be acquired from other than the mobile station reception information. For example, satellite coordinates included in the base station reception information received by the first reception unit 11 can also be used. Further, the server 30 can use satellite coordinates obtained from a service provider of a virtual reference station (VRS) via the Internet by using the network RTK service (not illustrated). Hereinafter, as the satellite coordinates in the present disclosure, the satellite coordinates included in the mobile station reception information are illustrated as an example.

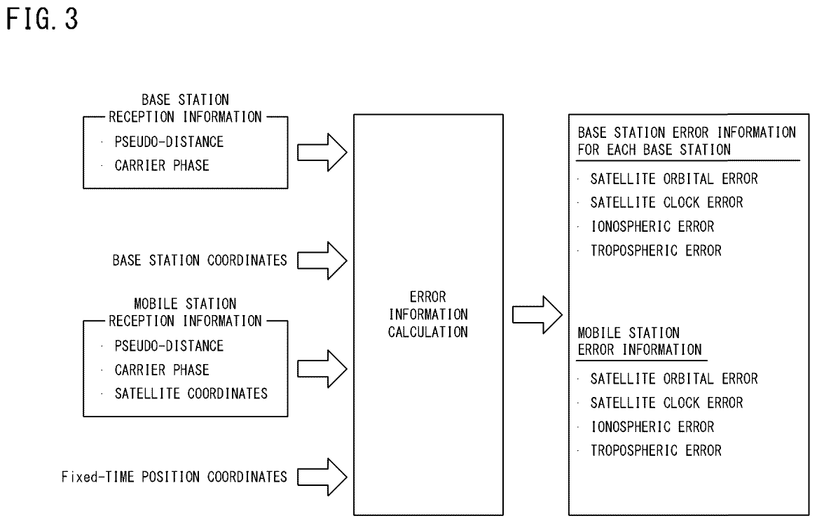

FIG. 3 is a conceptual diagram of derivation of error information. The first calculator 33 of the server 30 is configured or programmed to derive the base station error information and the mobile station error information as the error information. The base station error information and the mobile station error information are derived by the first calculator 33 by error information calculation based on the base station reception information, the base station coordinates, the mobile station reception information, and the fixed-time position coordinates. As described above, the prediction system 1 includes the plurality of base stations 10. Thus, the first calculator 33 is configured or programmed to derive the base station error information for each of the plurality of base stations 10. The base station reception information used to derive the error information includes at least a pseudo-distance and a carrier phase. The mobile station reception information used to derive the error information includes at least a pseudo-distance and a carrier phase. Similarly to FIG. 2, FIG. 3 illustrates a conceptual diagram in which the mobile station reception information includes satellite coordinates.

Examples of the error information include a satellite orbital error, a satellite clock error, a reception unit clock error, an ionospheric delay error, a tropospheric delay error, an integer bias, a position offset, and the like. The base station error information and the mobile station error information of the present disclosure each include at least one of a satellite orbital error, a satellite clock error, a reception unit clock error, an ionospheric delay error, a tropospheric delay error, an integer bias, or a position offset. FIG. 3 illustrates an example in which the first calculator 33 derives a satellite orbital error, a satellite clock error, an ionospheric delay error, and a tropospheric delay error for each of the base station error information and the mobile station error information. Note that, in the present disclosure, the satellite orbital error and the satellite clock error included in the base station error information are common to the satellite orbital error and the satellite clock error included in the mobile station error information. Therefore, it is only necessary that the satellite orbital error and the satellite clock error is included in at least one of the base station error information or the mobile station error information. Hereinafter, as the satellite orbital error and the satellite clock error in the present disclosure, the satellite orbital error and the satellite clock error included in both the base station error information and the mobile station error information are illustrated as an example.

Among the error information, error information accompanied by a temporal change is information that easily affects the occurrence of positioning abnormality. Examples of the error information accompanied by a temporal change include a satellite orbital error, a satellite clock error, a reception unit clock error, an ionospheric delay error, and a tropospheric delay error. In particular, the ionospheric delay error and the tropospheric delay error greatly affect the occurrence of positioning abnormality. Therefore, it is preferable that the error information includes at least the ionospheric delay error and the tropospheric delay error.

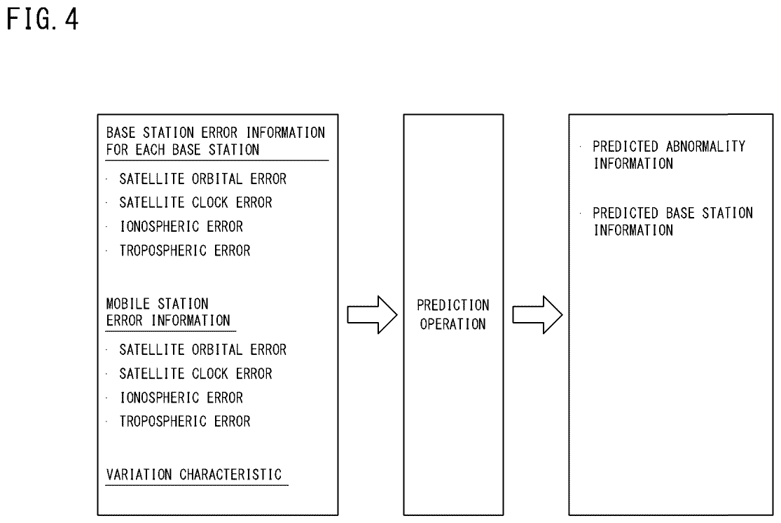

FIG. 4 is a conceptual diagram of derivation of predicted abnormality information and predicted base station information. The predicted abnormality information is information to predict the occurrence of positioning abnormality in the mobile station 20. The predicted base station information is information for setting a base station to be switched, which is a transmission source of the RTK correction information, when a positioning abnormality occurs in the mobile station 20. Both the predicted abnormality information and the predicted base station information are derived by the prediction calculation by the calculator of the server 30 corresponding to the second calculator 34 and the fifth calculator 35. In the prediction calculation, as the input information, the base station error information and the mobile station error information for each of the plurality of base stations 10, which are derived by the error information calculation by the first calculator 33 illustrated in FIG. 3, and a variation characteristic stored in the third storage 31 are used. The error information used to derive the predicted abnormality information and the predicted base station information preferably includes the above-described error information accompanied by a temporal change, and particularly preferably includes at least the ionospheric delay error and the tropospheric delay error.

FIG. 4 illustrates an example in which a satellite orbital error, a satellite clock error, an ionospheric delay error, and a tropospheric delay error are respectively used as the base station error information and the mobile station error information for each base station as the input information of the prediction calculation. Similarly to FIG. 3, FIG. 4 illustrates a case where the satellite orbital error and the satellite clock error are included in both the base station error information and the mobile station error information. The variation characteristic used to derive the predicted abnormality information and the predicted base station information is information indicating a relationship among a first change amount that is a change amount of the base station error information accompanied by a lapse of time, a second change amount that is a change amount of the mobile station error information accompanied by a lapse of time, and an occurrence of a positioning abnormality in the positioning information of the mobile station 20. Note that machine learning can also be applied to derive the variation characteristic. More specifically, by applying machine learning to a pseudo distance and a carrier phase in the base station error information and the mobile station error information for one or more years in the past, it is possible to derive a variation characteristic from a result of estimating each component included in the error information for each region, time, and season, for example.

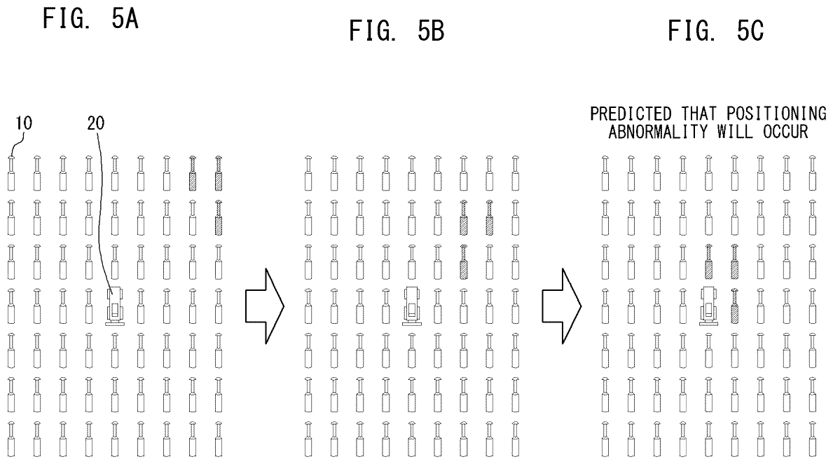

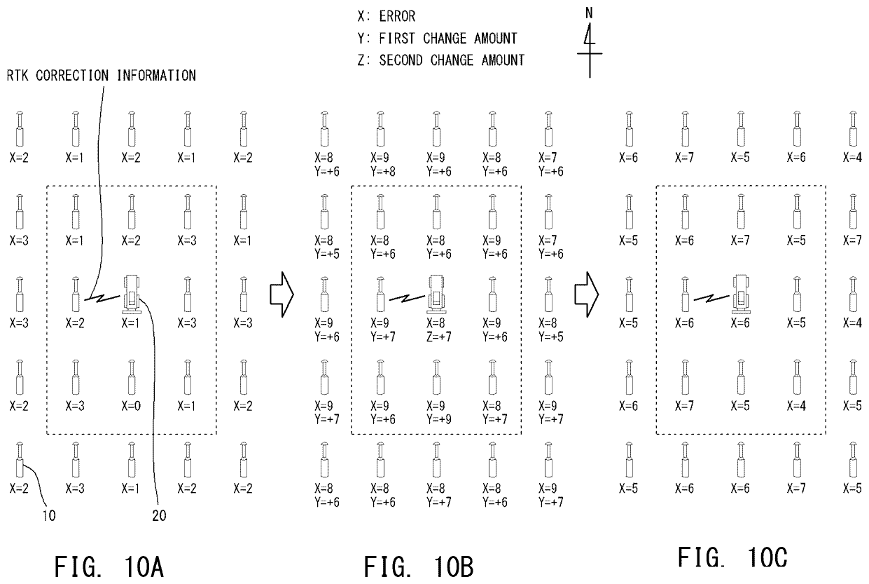

FIGS. 5A to 5C are explanatory diagrams for describing a first case of deriving predicted abnormality information. FIGS. 5A to 5C conceptually illustrates the mobile station 20 located at the center and a plurality of base stations 10 located around the mobile station 20. In FIGS. 5A to 5C, the base station 10 in which the first change amount, which is the change amount of the base station error information accompanied by a lapse of time, exceeds a reference is indicated by hatching. In the case of deriving the predicted abnormality information illustrated in FIGS. 5A to 5C, 10 minutes is set as the lapse of time, for example. The first change amount includes a change amount of, for example, 10 minutes of each of the satellite orbital error, the satellite clock error, the ionospheric delay error, and the tropospheric delay error included in the base station error information for each base station derived by the first calculator 33. The above reference can be arbitrarily changed as setting items of the server 30. For example, in the present example embodiment, among the plurality of base stations 10, a base station 10 in which the difference in the first change amount from another base station located nearest to the base station 10 is equal to or more than 10 cm, for example, can be set as the base station 10 exceeding the reference. Here, the difference in the first change amount is a difference in inter-satellite receiver distances including a satellite orbital error, a satellite clock error, an ionospheric delay error, and a tropospheric delay error between the target base station 10 and another base station 10 located nearest to the target base station 10. Note that, as the satellite clock error, a value obtained by multiplying the satellite clock error by the light speed (299792458 m/s) and converting the multiplied value as the distance can be used.

In FIGS. 5A to 5C, an arrow indicates a lapse of time of 10 minutes, for example. That is, FIG. 5C illustrates a current state of the positional relationship between the mobile station 20 and the base station 10 in which the first change amount exceeds the reference. FIG. 5B illustrates a state of the positional relationship between the mobile station 20 and the base station 10, in which the first change amount exceeds the reference, 10 minutes prior to FIG. 5C. FIG. 5A illustrates a state of the positional relationship between the mobile station 20 and the base station 10, in which the first change amount exceeds the reference, 10 minutes prior to FIG. 5C. It can be seen from FIGS. 5A to 5C that the base station position of the base station 10, in which the first change amount exceeds the reference, approaches the mobile station 20 accompanied by a lapse of time. FIGS. 5A to 5C illustrate that predicted abnormality information indicating that a positioning abnormality will occur is derived in the mobile station 20 in the state illustrated in FIG. 5C.

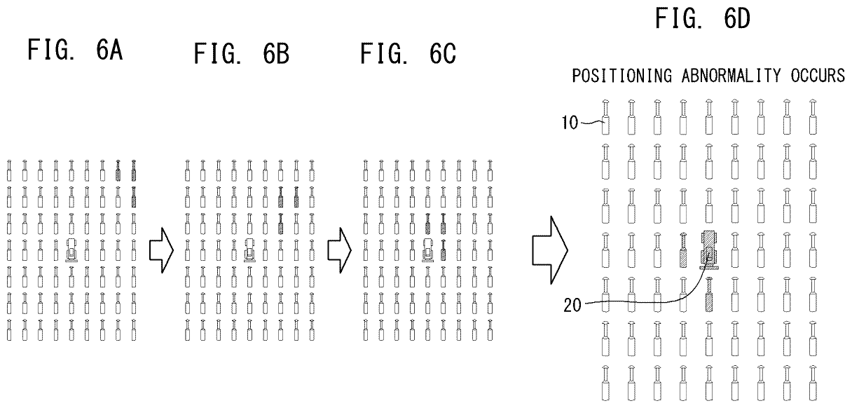

FIGS. 6A to 6D are explanatory diagrams for describing a variation characteristic used to derive predicted abnormality information that a positioning abnormality will occur in FIG. 5C. In FIGS. 6A to 6D, the base station 10 in which the first change amount, which is the change amount of the base station error information accompanied by a lapse of time, exceeds the reference is indicated by hatching as in FIGS. 5A to 5C. Further, in FIGS. 6A to 6D, the mobile station 20 in which the second change amount, which is the change amount of the mobile station error information accompanied by a lapse of time, exceeds the reference is indicated by hatching. Aspects of the lapse of time, the second change amount, and the reference in the variation characteristic illustrated in FIGS. 6A to 6D are similar to the aspects of the lapse of time, the first change amount, and the reference in the case of deriving the predicted abnormality information illustrated in FIGS. 5A to 5C. That is, the lapse of time is set to 10 minutes. The second change amount includes a change amount in 10 minutes of each of the satellite orbital error, the satellite clock error, the ionospheric delay error, and the tropospheric delay error included in the mobile station error information of the mobile station 20 derived by the first calculator 33, for example. The reference can be arbitrarily changed as a setting item of the server 30. For example, in a case where the difference between the second change amount of the mobile station 20 and the first change amount of the nearest base station is equal to or more than 10 cm, for example, the mobile station 20 exceeds the reference. More specifically, in a case where a difference between inter-satellite receiver distances in 10 minutes of the mobile station 20 and a difference between inter-satellite receiver distances in 10 minutes of the nearest base station is equal to or more than 10 cm, for example, the mobile station 20 exceeds the reference. FIG. 6D illustrates a state in which the second change amount of the mobile station 20 exceeds the reference and a positioning abnormality occurs in the mobile station 20.

In FIGS. 6A to 6D, an arrow indicates a lapse of time of 10 minutes, for example, as in FIGS. 5A to 5C. FIGS. 6A to 6C illustrate the positional relationship between the mobile station 20 and the base station 10 in which the first change amount exceeds the reference similarly to FIGS. 5A to 5C, respectively. Here, the variation characteristic illustrated in FIGS. 6A to 6D includes information indicating that a positioning abnormality has occurred in the mobile station 20 in the state of FIG. 6D after a further lapse of time from FIG. 6C.

FIGS. 5A to 5C illustrate a state of the positional relationship between the mobile station 20 and the base station 10 in which the first change amount exceeds the reference, which is similar to FIGS. 6A to 6C. More specifically, both a state change accompanied by a lapse of time illustrated in FIGS. 5A to 5C and a state change accompanied by a lapse of time illustrated in FIGS. 6A to 6C have similarity that the base station position of the base station 10 in which the first change amount exceeds the reference approaches the mobile station 20 accompanied by a lapse of time. Thus, the second calculator 34 refers to the variation characteristic illustrated in FIGS. 6A to 6D in deriving the predicted abnormality information of the mobile station 20 in the state illustrated in FIGS. 5A to 5C. Then, the second calculator 34 is configured or programmed to the predicted abnormality information that the positioning abnormality will occur in the mobile station 20 at the stage of the state illustrated in FIG. 5C based on the variation characteristic that the positioning abnormality occurs in the mobile station 20 in the state of FIG. 6D in which the time has further elapsed from FIG. 6C corresponding to FIG. 5C. Thus, the prediction system 1 can predict the occurrence of the positioning abnormality in the mobile station 20 with excellent accuracy before the positioning abnormality occurs in the mobile station 20.

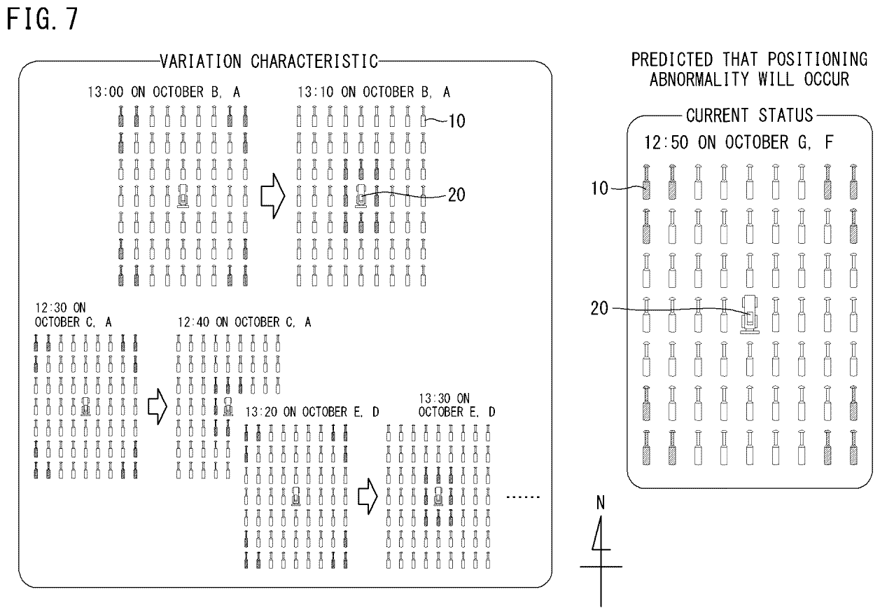

FIG. 7 is an explanatory diagram for describing a second case of deriving the predicted abnormality information. The compass rose in FIG. 7 indicates directions in a conceptual diagram of the positions of the mobile station 20 and the plurality of base stations 10 indicated in the variation characteristic and the current situation. In the second case of deriving the predicted abnormality information illustrated in FIG. 7, the variation characteristic including past records indicating the relationship between information of the first change amount at the base station position of each of the plurality of base stations 10 and an occurrence of the positioning abnormality in the mobile station 20 in a predetermined period and a predetermined time zone is used.

FIG. 7 illustrates the situation of the positional relationship between the mobile station 20 and the base station 10 in which the first change amount exceeds the reference as of 12:50 on October G, F. FIG. 7 illustrates, as variation characteristics, past records before October G, F indicating a change in the positional relationship between the mobile station 20 and the base station 10 in which the first change amount exceeds the reference accompanied by a lapse of time from 10 minutes prior to the occurrence of the positioning abnormality to the occurrence of the positioning abnormality in the positioning abnormality of the mobile station 20, which has occurred around 13:00 in October. For example, FIG. 7 illustrates, as one of the variation characteristics, a state of a positional relationship between the mobile station 20 at 13:00 on October B, A and the base station 10 in which the first change amount exceeds the reference, and a state of a positional relationship between the mobile station 20 at 13:10 on October B, A in which a positioning abnormality has occurred and the base station 10 in which the first change amount exceeds the reference in the mobile station 20.

As illustrated in FIG. 7, in the occurrence of the positioning abnormality of the mobile station 20 that has occurred around 13:00 in October, there is a plurality of displacement characteristics indicating that the first change amount exceeds the reference in the base stations 10 located in the northwest, the northeast, the southeast, and the southwest with respect to the mobile station 20 10 minutes before the occurrence of the positioning abnormality. The current situation is 12:50 in October, and has similarity with the state 10 minutes before the occurrence of the positioning abnormality in the displacement characteristic. Thus, the second calculator 34 refers to the variation characteristic illustrated in FIG. 7 in deriving the predicted abnormality information of the mobile station 20. Then, the second calculator 34 is configured or programmed to the predicted abnormality information that a positioning abnormality occurs in the mobile station 20 at the stage of the current situation based on the variation characteristic that the positioning abnormality will occur in the mobile station 20 after 10 minutes illustrated in FIG. 7. Thus, the prediction system 1 can predict the occurrence of the positioning abnormality in the mobile station 20 with excellent accuracy before the positioning abnormality occurs in the mobile station 20.

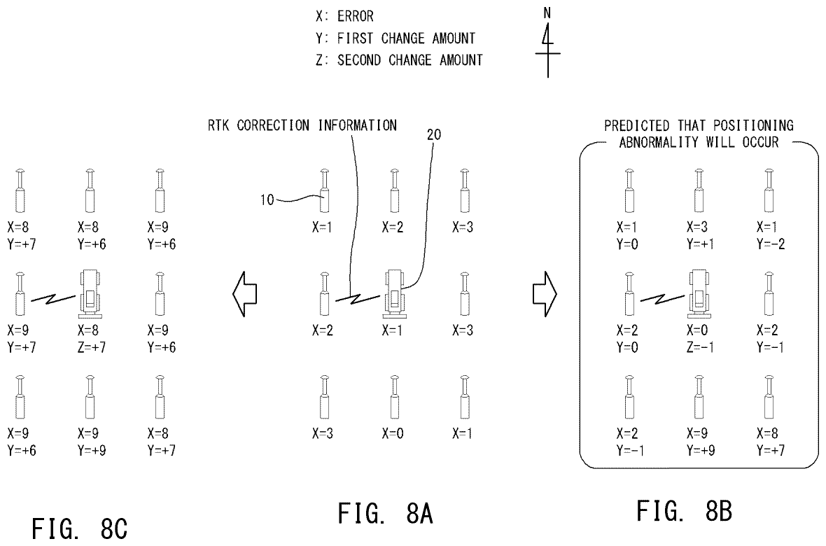

FIGS. 8A to 8C are explanatory diagrams for describing a third case of deriving the predicted abnormality information. FIGS. 8A to 8C illustrate conceptual diagrams of positions of the mobile station 20 and a plurality of base stations 10 located nearest to the mobile station 20. The compass rose in FIGS. 8A to 8C indicates directions in the conceptual diagrams illustrated in FIGS. 8A to 8C. A zigzag line illustrated in FIGS. 8A to 8C indicates the relationship between the base station 10 that is the transmission source of the RTK correction information and the mobile station 20.

The error illustrated in FIGS. 8A to 8C indicates the magnitude of each of the mobile station error information and the base station error information in 10 steps of 0 to 9. The magnitudes of the mobile station error information and the base station error information can be classified into 10 stages, for example, by measuring values of respective components included in the mobile station error information and the base station error information estimated by the extended Kalman filter in a normal state and an abnormal state in advance, classifying error amounts into 10 stages with a probability that the positioning accuracy is affected, and then confirming which classification of 10 stages the actually estimated error is in. In FIGS. 8A to 8C, the error is indicated by X below each of the base station 10 and the mobile station 20. The error described below the mobile station 20 indicates the magnitude of the mobile station error information. The error described under each of the plurality of base stations 10 indicates the magnitude of each piece of base station error information.

In FIGS. 8A to 8C, an arrow indicates a lapse of time of, for example, 10 minutes as in FIGS. 5A to 5C. For example, from FIG. 8A which is a conceptual diagram of the mobile station 20 and the plurality of base stations 10 located nearest to the mobile station 20 illustrated in the center of FIGS. 8A to 8C, it can be seen that, in FIG. 8B which is a conceptual diagram indicated by an arrow in the right direction, the error of the mobile station 20 changes from 1 to 0 with the lapse of time of 10 minutes, for example. On the other hand, in FIG. 8C, which is a conceptual diagram indicated by an arrow in the left direction, it can be seen that the error of the mobile station 20 changes from 1 to 8 with the lapse of time.

In FIGS. 8A to 8C, the first change amount is described below each of the plurality of base stations 10 located nearest to the mobile station 20. Further, the second change amount is described below the mobile station 20. In FIGS. 8A to 8C, the first change amount is indicated by Y below the base station 10. Further, the second change amount is indicated by Y below the mobile station 20. For example, in FIG. 8B, as described above, since the error of the mobile station 20 changes from 1 to 0 with the lapse of time from FIG. 8A, the second change amount is −1. In FIG. 8B, since the error of the base station 10 located in the east of the mobile station 20 has changed from 3 to 2 with the lapse of time from FIG. 8A, the first change amount is −1. In FIG. 8C, as described above, since the error of the mobile station 20 has changed from 1 to 8 with the lapse of time from FIG. 8A, the second change amount is +7. In FIG. 8C, since the error of the base station 10 located in the east of the mobile station 20 has changed from 3 to 9 with the lapse of time from FIG. 8A, the first change amount is +6.

As described above, in the prediction system 1 according to an example embodiment of the present disclosure, the fixed-time position coordinates that are the positioning information of the mobile station 20 are derived by RTK-GNSS positioning measurement. Here, in the RTK-GNSS positioning, when the magnitude of the base station error information of the base station 10 that is the transmission source of the RTK correction information and the magnitude of the mobile station error information of the mobile station 20 are substantially the same, accuracy of the fixed-time position coordinates derived by positioning calculation based on the RTK correction information is ensured. This is because the base station error information and the mobile station error information are offset by the positioning calculation based on the RTK correction information. Conversely, as the magnitude of the base station error information of the base station 10 that is the transmission source of the RTK correction information and the magnitude of the mobile station error information of the mobile station 20 deviate from each other, the accuracy of the fixed-time position coordinates decreases. Note that, in the present disclosure, in a case where the difference between the error of the base station 10 that is the transmission source of the RTK correction information and the error of the mobile station 20, which is indicated by 10 stages, is equal to or less than −6 or equal to or more than +6, a positioning abnormality occurs in the mobile station 20. Conversely, in a case where the difference between the errors is equal to or more than −6 and equal to or less than +6, no positioning abnormality occurs in the mobile station 20.

In FIGS. 8A to 8C, the mobile station 20 receives the RTK correction information from the nearest base station 10 located to the west of the mobile station 20. An error of the base station 10 that is a transmission source of the RTK correction information illustrated in FIG. 8A is 2. The error of the mobile station 20 illustrated in FIG. 8A is 1. That is, in FIG. 8A, the difference between the error of the base station 10 that is the transmission source of the RTK correction information and the error of the mobile station 20 is +1(=2−1). That is, in FIG. 8A, the error difference is equal to or more than −6 and equal to or less than +6. Therefore, no positioning abnormality occurs in the mobile station 20.

An error of the base station 10 that is a transmission source of the RTK correction information illustrated in FIG. 8B is 2. The error of the mobile station 20 illustrated in FIG. 8B is 0. That is, in FIG. 8B, the difference between the error of the base station 10 that is the transmission source of the RTK correction information and the error of the mobile station 20 is +2(=2−0). That is, in FIG. 8B, the error difference is equal to or more than −6 and equal to or less than +6. Therefore, no positioning abnormality occurs in the mobile station 20. Here, the difference between the first change amount of the base station 10 that is the transmission source of the RTK correction information and the second change amount of the mobile station 20 is 1(=0−(−1)). From this, it can be seen that, in the lapse of time from FIGS. 8A to 8B, no large variation occurs in the difference between the errors between the base station 10 that is the transmission source of the RTK correction information and the mobile station 20. On the other hand, the difference between the first change amount of the nearest base station 10 located to the south of the mobile station 20 and the second change amount of the mobile station 20 is 10(=(+9)−(−1)). In addition, the difference between the first change amount of the nearest base station 10 located in the southeast of the mobile station 20 and the second change amount of the mobile station 20 is 9(=(+8)−(−1)). From this, it can be seen that in the lapse of time from FIGS. 8A to 8B, a large variation occurs in the difference between the above errors between the nearest base station 10 located in the south and the southeast of the mobile station 20 and the mobile station 20. Note that, in the present disclosure, in a case where the difference between the first change amount of the base station 10 and the second change amount of the mobile station 20 is equal to or less than −6 or equal to or more than +6, it is determined that a large variation has occurred in the difference between the errors. Conversely, in a case where the difference between the first change amount of the base station 10 and the second change amount of the mobile station 20 is equal to or more than −6 and equal to or less than +6, it is determined that no large variation has occurred in the difference between the errors.

An error of the base station 10 that is a transmission source of the RTK correction information illustrated in FIG. 8C is 9. An error of the mobile station 20 illustrated in FIG. 8C is 8. That is, in FIG. 8C, the difference between the error of the base station 10 that is the transmission source of the RTK correction information and the error of the mobile station 20 is +1(=9−8). That is, in FIG. 8C, the error difference is equal to or more than −6 and equal to or less than +6. Therefore, no positioning abnormality occurs in the mobile station 20. Here, in FIG. 8C, the first change amount of the base station 10 that is the transmission source of the RTK correction information is +7. On the other hand, in FIG. 8B, the first change amount of base station 10 that is the transmission source of the RTK correction information is 0. That is, the first change amount of the base station 10 that is the transmission source of the RTK correction information changes more greatly in FIG. 8C than in 8B with the lapse of time. However, in FIG. 8C, the first change amount of the mobile station 20 also greatly changes to +7. Therefore, in FIG. 8C, the difference between the first change amount of the base station 10 that is the transmission source of the RTK correction information and the second change amount of the mobile station 20 is 0(=(+7)−(+7)), and it can be seen that no large fluctuation occurs in the difference between the errors. Here, in FIG. 8C, +2(=(+9)−(+7)) of the difference between the first change amount of the nearest base station 10 located on the south side of the mobile station 20 and the second change amount of the mobile station 20 is the maximum difference between the first change amount of the nearest base station 10 of the mobile station 20 and the second change amount of the mobile station 20. That is, in FIG. 8C, it can be seen that the errors of the base station 10 nearest to the mobile station 20 and the mobile station 20 have become larger as a whole with the lapse of time from FIG. 8A. In this case, as described above, in the RTK-GNSS positioning, the base station error information and the mobile station error information are offset, so that the accuracy of the fixed-time position coordinates is secured.

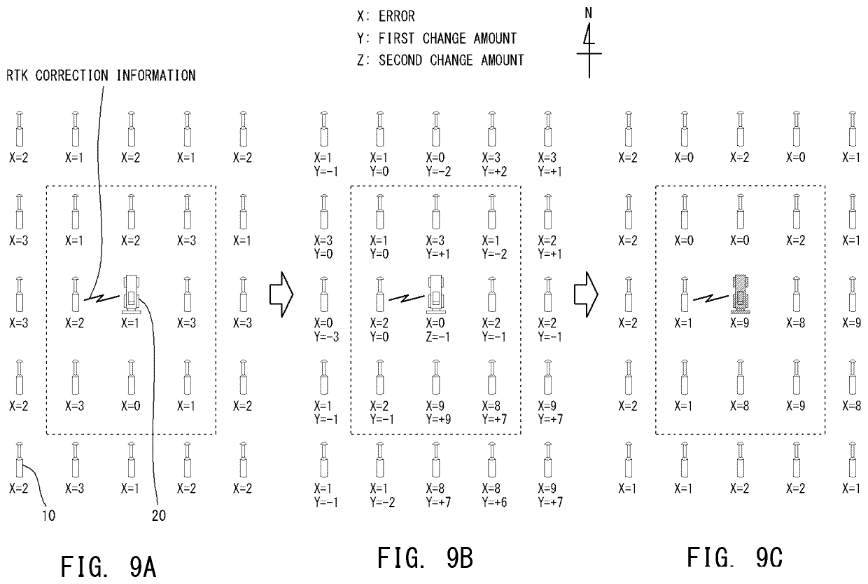

In the third case of the present disclosure, information indicating the relationship between the difference between the first change amount of each of the plurality of base stations 10 and the second change amount of the mobile station 20 and the occurrence of positioning abnormality is used as a variation characteristic. FIGS. 9A to 9C are explanatory diagrams for describing a variation characteristic used when the predicted abnormality information that a positioning abnormality occurs is derived in FIG. 8B. Dashed lines illustrated in FIGS. 9A to 9C each indicate the nearest area of the mobile station 20. FIGS. 9A to 9C illustrate examples of the variation characteristic in which the states of the conceptual diagrams of the mobile station 20 and the plurality of base stations 10 located nearest to the mobile station 20 illustrated in the dashed lines in FIGS. 9A and 9B are the same as the states illustrated in FIGS. 8A and 8B, respectively, in order to facilitate understanding of derivation of the predicted abnormality information based on the variation characteristic by the second calculator 34 in the third case.

FIG. 9C illustrates a conceptual diagram of the mobile station 20 and the plurality of base stations 10 after a lapse of, for example, 10 minutes from FIG. 9B. An error of the base station 10 that is a transmission source of the RTK correction information illustrated in FIG. 9C is 1. The error of the mobile station 20 illustrated in FIG. 9C is 9. That is, in FIG. 9C, the difference between the error of the base station 10 that is the transmission source of the RTK correction information and the error of the mobile station 20 is −8(=1−9). That is, in FIG. 9C, the difference between the errors is equal to or less than −6. Therefore, in the mobile station 20, a positioning abnormality occurs. Note that, in FIG. 9C, the mobile station 20 in which the positioning abnormality has occurred is indicated by hatching.

The state of the conceptual diagram of the mobile station 20 and the plurality of base stations 10 located nearest to the mobile station 20 illustrated in the dashed line of FIG. 9A is similar to the state illustrated in FIG. 8A. The state of the conceptual diagram of the mobile station 20 and the plurality of base stations 10 located nearest to the mobile station 20 illustrated in the dashed line of FIG. 9B is similar to the state illustrated in FIG. 8B. Therefore, the second calculator 34 refers to the variation characteristic illustrated in FIGS. 9A to 9C in deriving the predicted abnormality information of the mobile station 20 in a state change accompanied by a lapse of time from FIGS. 8A to 8B. Then, the second calculator 34 is configured or programmed to the predicted abnormality information that the positioning abnormality will occur in the mobile station 20 at the stage of the state illustrated in FIG. 8B based on the variation characteristic that the positioning abnormality occurs in the mobile station 20 in the state of FIG. 9C in which the time further elapses from FIG. 9B corresponding to FIG. 8B. Thus, the prediction system 1 can predict the occurrence of the positioning abnormality in the mobile station 20 with excellent accuracy before the positioning abnormality occurs in the mobile station 20.

FIGS. 10A to 10C are explanatory diagrams for describing a variation characteristic used when the predicted abnormality information that a positioning abnormality will occur is not derived in FIG. 8C. FIGS. 10A to 10C are the same as FIGS. 9A to 9C except for values of the error, the first change amount, and the second change amount. In the variation characteristic illustrated in FIGS. 10A to 10C, the error entirely fluctuates in the area including the nearest mobile station 20 with the lapse of time to FIGS. 10A to 10. Therefore, in FIGS. 10A to 10C, the difference between the error of the base station 10 that is the transmission source of the RTK correction information and the error of the mobile station 20 is equal to or more than −6 and equal to or less than +6. Therefore, no positioning abnormality occurs in the mobile station 20.

The state of the conceptual diagram of the mobile station 20 and the plurality of base stations 10 located nearest to the mobile station 20 illustrated in the dashed line of FIG. 10A is similar to the state illustrated in FIG. 8C. The state of the conceptual diagram of the mobile station 20 and the plurality of base stations 10 located nearest to the mobile station 20 illustrated in the dashed line of FIG. 10B is similar to the state illustrated in FIG. 8C. Therefore, the second calculator 34 refers to the variation characteristic illustrated in FIGS. 10A to 10C. As described above, no positioning abnormality occurs in the state of FIG. 9C after further elapse of time from 11B. Therefore, in the state illustrated in FIG. 8C, the second calculator 34 does not derive predicted abnormality information that a positioning abnormality will occur in the mobile station 20.

As in the third case of the present disclosure, the third storage 31 of the server 30 may be configured to store, as the variation characteristics, a variation characteristic when the predicted abnormality information that a positioning abnormality will occur is derived as illustrated in FIGS. 9A to 9C, and a variation characteristic when the predicted abnormality information that a positioning abnormality occurs is not derived as illustrated in FIGS. 10A to 10C. Thus, the prediction system 1 can predict the occurrence of the positioning abnormality in the mobile station 20 with more excellent accuracy before the positioning abnormality occurs in the mobile station 20.

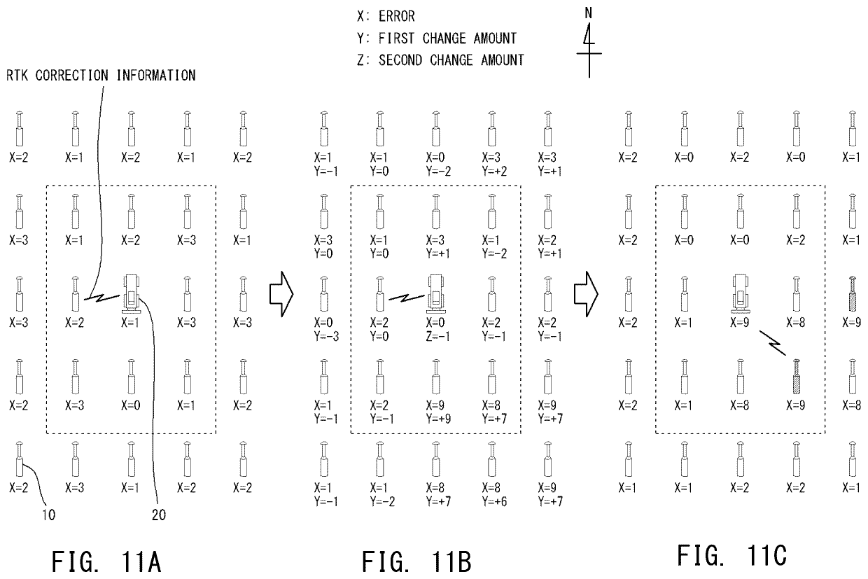

FIGS. 11A to 11C are explanatory diagrams for describing a derivation case of predicted base station information. In the derived case of the predicted base station information of the present disclosure, in the above-described third case of deriving the predicted abnormality information, an example of deriving the predicted base station information from the variation characteristic illustrated in FIGS. 9A to 9C in the state of FIG. 8B in which the predicted abnormality information that the positioning abnormality will occur is derived is illustrated. FIGS. 11A to 11C correspond to FIGS. 9A to 9C, respectively. FIGS. 11A and 11B are the same as FIGS. 9A and 9B, respectively. FIG. 11C is different from FIG. 9C in base station 10 that is a transmission source of the RTK correction information. More specifically, in FIG. 11C, the base station 10 that is the transmission source of the RTK correction information is replaced with the nearest base station 10 located in the west of the mobile station 20 in FIG. 9C, and is replaced with the nearest base station 10 located in the southeast of the mobile station 20. In addition, in FIG. 11C, the base station 10 having the same error as the error of the mobile station 20 is indicated by hatching.

The fifth calculator 35 of the server 30 extracts the base station 10 having the same error as the error of the mobile station 20 from FIG. 9C when the second calculator 34 is configured or programmed to the predicted abnormality information that the positioning abnormality will occur in the state of FIG. 8B based on the variation characteristic illustrated in FIGS. 9A to 9C. That is, the fifth calculator 35 extracts the base station 10 indicated by hatching in FIG. 11C. As described above, in the RTK-GNSS positioning, the base station error information and the mobile station error information are offset by the positioning calculation based on the RTK correction information. Therefore, in FIG. 11C, base station 10 indicated by hatching is a candidate for the transmission source of the RTK correction information.

As the base station 10 that is the transmission source of the RTK correction information is closer to the mobile station 20, the ionospheric delay error and the tropospheric delay error tend to approach the ionospheric delay error and the tropospheric delay error in the mobile station 20, and the reliability of the RTK correction information is improved. Therefore, the fifth calculator 35 derives the predicted base station information in which the base station 10 nearest to the mobile station 20 among the extracted base stations 10 is set as the transmission source of the RTK correction information. That is, as illustrated in FIG. 11C, the fifth calculator 35 derives the predicted base station information in which the nearest base station 10 located in the southeast of the mobile station 20 is set as the transmission source of the RTK correction information. Note that the derived predicted base station information is transmitted from the third communication unit 32 of the server 30 and received by the second communication unit 215 in the positioning detection device 21 of the mobile station 20. The predicted base station information received by the second communication unit 215 is stored in the second storage 212.

As described above, the derivation of the predicted base station information by the fifth calculator 35 is performed when the predicted abnormality information that a positioning abnormality will occur is derived in FIG. 8B. That is, the prediction system 1 can set the base station 10 to be switched, which is the transmission source of the RTK correction information, in the mobile station 20 before the positioning abnormality will occur. This makes it possible to smoothly switch the base station 10 when the positioning abnormality occurs. Therefore, when the positioning abnormality occurs, the fixed-time position coordinates of the mobile station 20 can be quickly derived based on the RTK correction information of the base station 10 to be switched set based on the predicted base station information. Thus, continuous automatic traveling of the mobile station 20 becomes possible, and work efficiency in the worksite is improved.

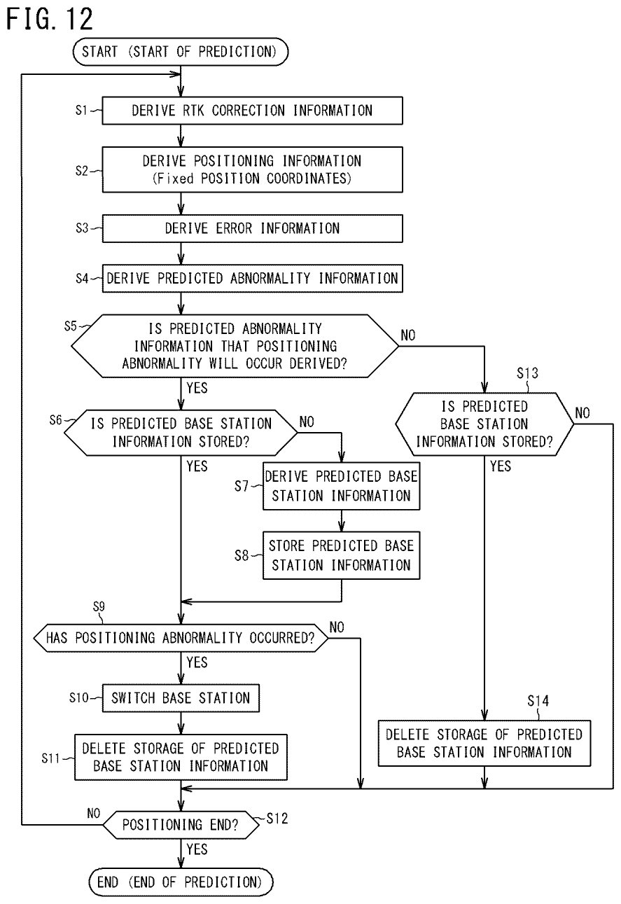

FIG. 12 is a flowchart illustrating a flow of processing by the prediction system 1 according to the first example embodiment of the present disclosure. The prediction system 1 is configured or programmed to execute steps S1 to S14 illustrated in FIG. 12 from start (prediction start) to end (prediction end).

As illustrated in FIG. 12, when the prediction is started in the prediction system 1, the fourth calculator 13 of the base station 10 executes S1 that is a step of deriving the RTK correction information based on the base station reception information from the satellite SAT received by the first reception unit 11 and the base station coordinates stored in the first storage 12. Note that, in the prediction system 1, the base station reception information and the base station coordinates are transmitted by the first communication unit 15 of the base station 10 and received by the third communication unit 32 of the server 30. Furthermore, in the prediction system 1, the RTK correction information is transmitted by the transmission unit 14 of the base station 10, and received by the third reception unit 214 in the positioning detection device 21 of the mobile station 20.

In the positioning detection device 21 of the mobile station 20, the third calculator 213 executes S2 that is a step of deriving the fixed-time position coordinates as the positioning information of the mobile station 20 based on the RTK correction information derived in S1 and the mobile station reception information received by the second reception unit 211 of the positioning detection device 21. Note that, in the prediction system 1, the mobile station reception information and the fixed-time position coordinates are transmitted by the second communication unit 215 in the positioning detection device 21 of the mobile station 20 and received by the third communication unit 32 of the server 30.

The first calculator 33 of the server 30 executes S3 that is a step of deriving the base station error information of the base station 10 and the mobile station error information of the mobile station 20 based on the base station reception information, the base station coordinates, the mobile station reception information, and the fixed-time position coordinates received by the third communication unit 32. Next, the second calculator 34 of the server 30 executes S4 that is a step of deriving predicted abnormality information based on the base station error information and the mobile station error information derived in S3 and the variation characteristic stored in the third storage 31. Note that, in the prediction system 1, the predicted abnormality information is transmitted by the third communication unit 32 and received by the second communication unit 215 in the positioning detection device 21 of the mobile station 20.

The second calculator 34 of the server 30 executes S5 that is a step of determining whether or not the predicted abnormality information that a positioning abnormality will occur is derived in S4. When it is determined in S5 that the predicted abnormality information that the positioning abnormality will occur is derived, the second calculator 34 executes S6 that is a step of determining whether or not the predicted base station information is stored in the second storage 212 of the mobile station 20. When it is determined in S6 that the predicted base station information is stored, the process proceeds to S9.

When it is determined in S6 that the predicted base station information is not stored, the fifth calculator 35 of the server 30 executes S7 that is a step of deriving the predicted base station information based on the base station error information, the mobile station error information, and the variation characteristic. In the prediction system 1, the predicted base station information derived in S7 is transmitted by the third communication unit 32 and received by the second communication unit 215 in the positioning detection device 21 of the mobile station 20. The predicted base station information received by the second communication unit 215 is stored in the second storage 212 in the positioning detection device 21 of the mobile station 20 in step S8.

The second calculator 34 of the server 30 executes S9 that is a step of determining whether or not a positioning abnormality occurs based on the base station error information and the mobile station error information. In a case where it is determined in S9 that no positioning abnormality occurs, the process proceeds to S12 that is a step of determining whether or not there is an instruction to end prediction. When it is determined in S9 that the positioning abnormality has occurred, the third calculator 213 in the positioning detection device 21 of the mobile station 20 executes S10 that is a step of switching the base station 10 that is the transmission source of the RTK correction information based on the predicted base station information stored in the second storage 212. After the base station 10 that is the transmission source of the RTK correction information is switched in step S10, the predicted base station information stored in the second storage 212 is deleted from the storage in the second storage 212 in step S11, and the process shifts to step S12. Note that, in the prediction system 1, the prediction end instruction is input from an input unit included in the constituent device 221 in the tractor 22 of the mobile station 20.

When it is determined that there is an instruction to end the prediction in S2 that is a step of determining whether or not there is an instruction to end the prediction, the positioning ends and the process ends. When it is determined in S12 that there is no prediction end instruction, the process returns to S1.

When it is determined in S5 that the predicted abnormality information that the positioning abnormality will occur is not derived, the second calculator 34 executes S13 that is a step of determining whether or not the predicted base station information is stored in the second storage 212 of the mobile station 20. In a case where it is determined in S13 that the predicted base station information is stored, the predicted base station information stored in the second storage 212 is deleted from the storage of the second storage 212 in step S14, and the process proceeds to S12. In a case where it is determined in S13 that the predicted base station information is not stored, the process proceeds to S12.

Example embodiments disclosed herein are illustrative in all respects and are not restrictive. The scope of the present invention is not limited to the above-described example embodiments, and includes all modifications within the scope equivalent to the configurations described in the claims.

The prediction system 1 includes the base station 10, the mobile station 20, and the server 30, but prediction systems according to example embodiments of the present disclosure is not limited to this configuration. For example, a prediction system according to an example embodiment of the present disclosure can be configured not to include a server. In a case where the prediction system 1 does not include a server, for example, it is conceivable that the first communication unit 15 of the base station 10 and the second communication unit 215 of the mobile station 20 transmit and receive information between the base station 10 and the mobile station 20, and the positioning detection device 21 of the mobile station 20 includes the third storage 31, the first calculator 33, the second calculator 34, and the fifth calculator 35.

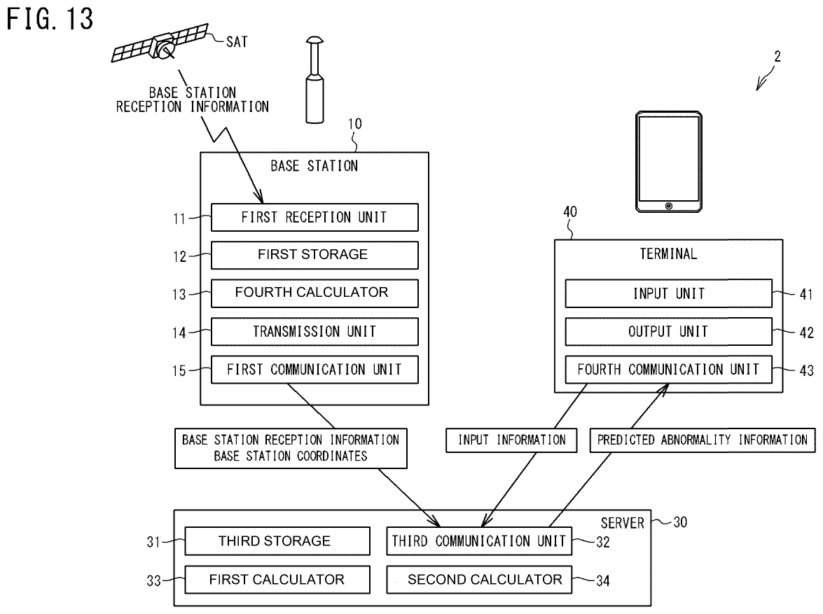

A prediction system according to an example embodiment of the present disclosure can be configured not to include a mobile station. Examples of the prediction system not including a mobile station include a prediction system that derives predicted abnormality information to predict an occurrence of a positioning abnormality at a predetermined position. FIG. 13 is a schematic diagram illustrating an overall configuration of a prediction system 2 according to a second example embodiment of the present disclosure. The prediction system 2 includes a terminal 40 instead of the mobile station 20 of the prediction system 1. As the terminal 40, a known terminal such as a smartphone, a tablet, or a personal computer can be applied. In the prediction system 2 illustrated in FIG. 13, the same configurations as those of the prediction system 1 illustrated in FIG. 1 are denoted by the same reference numerals and the same names.

The terminal 40 includes an input unit 41, an output unit 42, and a fourth communication unit 43. The input unit 41 has an input function to input a predetermined position to predict an occurrence of a positioning abnormality. The output unit 42 has an output function to output predicted abnormality information to predict an occurrence of a positioning abnormality. The fourth communication unit 43 has a communication function for communicating with the server 30. The fourth communication unit 43 transmits input information and the like regarding the predetermined position input by the input unit 41 from the terminal 40 to the server 30. The fourth communication unit 43 receives information such as predicted abnormality information from the server 30 to the terminal 40.

In the prediction system 2, the first calculator 33 derives base station error information based on base station information and base station coordinates. In addition, the second calculator 34 is configured or programmed to predicted abnormality information at the predetermined position input by the input unit 41 based on the base station error information and a variation characteristic. The predicted abnormality information derived by the second calculator 34 is output to the output unit 42.

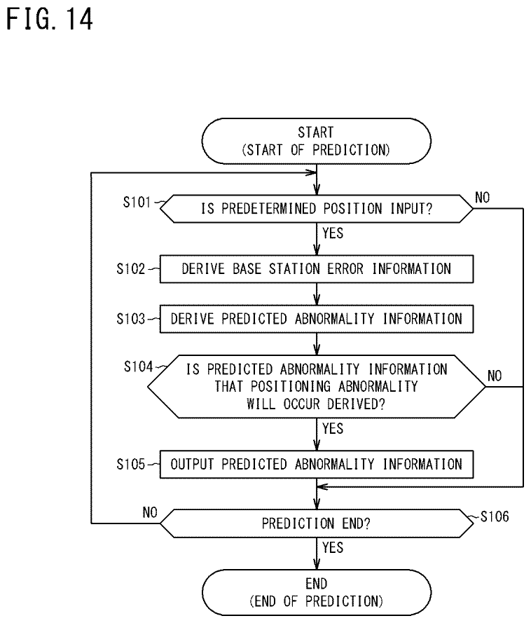

FIG. 14 is a flowchart illustrating a flow of prediction of an occurrence of a positioning abnormality by the prediction system 2 according to the second example embodiment of the present disclosure. The prediction system 1 is configured or programmed to be capable of executing steps of S101 to S106 illustrated in FIG. 14 from start (prediction start) to end (prediction end).

As illustrated in FIG. 14, when the prediction in the prediction system 2 is started, it is determined in step S101 whether or not there is an input of the predetermined position in the input unit 41 of the terminal 40. In a case where it is determined in S101 that there is no input of the predetermined position, the process proceeds to S106 that is a step of determining whether or not there is an instruction to end the prediction. Note that, in the prediction system 2, the instruction to end the prediction is input from the input unit 41.

In a case where it is determined in S101 that there is an input of the predetermined position, the first calculator 33 of the server 30 executes S102 which is a step of deriving the base station error information of the base station 10. Next, the second calculator 34 of the server 30 executes S103 that is a step of deriving the predicted abnormality information based on the base station error information derived in S102 and the variation characteristic stored in the third storage 31.

The second calculator 34 of the server 30 executes S104 that is a step of determining whether or not the predicted abnormality information that the positioning abnormality will occur is derived in S103. In a case where it is determined in S104 that the predicted abnormality information that the positioning abnormality will occur is not derived, the process proceeds to S106. In a case where it is determined in S104 that the predicted abnormality information that the positioning abnormality will occur is derived, the predicted abnormality information that the positioning abnormality will occur is output to the output unit 42 of the terminal 40 in step S105, and the process proceeds to S106.

When it is determined that there is an instruction to end the prediction in S106 that is a step of determining whether or not there is an instruction to end the prediction, the prediction ends and the process ends. In a case where it is determined in S106 that there is no prediction end instruction, the process returns to S101.

When the predicted abnormality information that the positioning abnormality will occur is derived, the prediction system 1 specifies the base station 10 that is the transmission source of the RTK correction information based on the predicted base station information, and switches the base station 10 that is the transmission source of the RTK correction information to the specified base station 10 when the positioning abnormality occurs, thereby continuing the derivation of the fixed-time position coordinates of the mobile station 20 by the RTK-GNSS positioning. However, the prediction system of the present disclosure is not limited to the continuation of the position identification of the mobile station by RTK-GNSS positioning. It is also possible to switch to position identification of the mobile station by dead reckoning when the positioning abnormality occurs. For example, by providing the mobile station with a sixth calculator that derives the position of the mobile station by dead reckoning based on various sensors such as a gyro sensor and an acceleration sensor and information from the various sensors, it is possible to switch to position identification of the mobile station by dead reckoning when a positioning abnormality occurs.

In FIG. 3 described in the above-described derivation of the error information, a conceptual diagram in which both the base station error information and the mobile station error information are derived is illustrated. Here, the first calculator 33 of the server 30 may continuously derive the base station error information based on the base station reception information and the base station coordinates in a state where the predicted abnormality information is not derived by the prediction system 1. Further, similarly in the prediction system 2, the first calculator 33 of the server 30 may continuously derive the base station error information in a state where the predicted abnormality information is not derived by the prediction system 2. Thus, when the prediction system 1 or the prediction system 2 starts deriving the predicted abnormality information, the predicted abnormality information can be quickly derived.

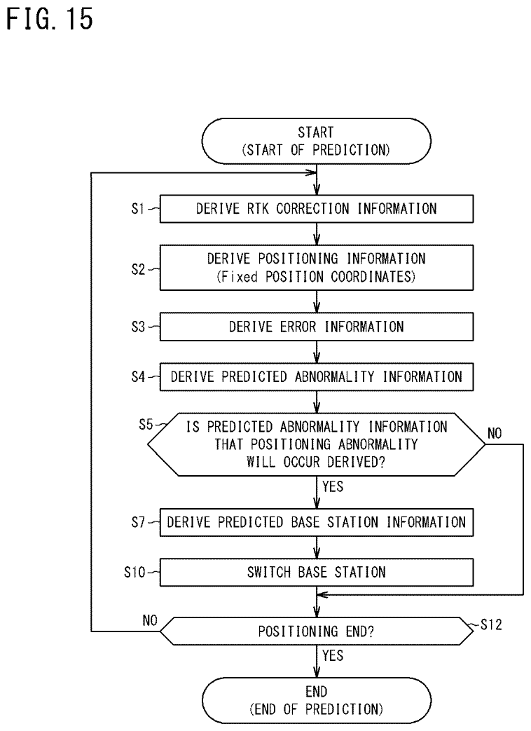

The prediction system 1 switches the base station 10 that is the transmission source of the RTK correction information when the positioning abnormality occurs, but the switching may be performed before the positioning abnormality occurs. That is, the prediction systems according to example embodiments of the present disclosure are not limited to switching when a positioning abnormality occurs. For example, as illustrated in the flowchart of FIG. 15, the prediction system 1 may switch the base station 10 that is the transmission source of the RTK correction information when the predicted abnormality information is derived.

FIG. 15 illustrates a modification of the flowchart illustrated in FIG. 12. In FIG. 15, the steps denoted by the same numbers as the numbers of the steps illustrated in FIG. 12 are processed in the same manner as in the description of the steps in FIG. 12, and thus the description thereof will be partially omitted. In the processing of the modification of the flowchart illustrated in FIG. 15, in a case where it is determined in S5 that the predicted abnormality information that the positioning abnormality will occur is derived, S7 that is a step of deriving the predicted base station information is executed. The predicted base station information derived in S7 is transmitted to the positioning detection device 21 of the mobile station 20 by the third communication unit 32. The third calculator 213 in the positioning detection device 21 of the mobile station 20 executes S10 that is a step of switching the base station 10 that is the transmission source of the RTK correction information based on the received predicted base station information.

Further, the switching of the base station 10 that is the transmission source of the RTK correction information may be performed at timing other than the timing at which the predicted abnormality information is derived before the occurrence of the positioning abnormality. Note that the switching of the position identification of the mobile station by the above-described dead reckoning can also be performed before the occurrence of the positioning abnormality.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A prediction system to predict an occurrence of a positioning abnormality, the prediction system comprising:
a plurality of base stations to receive base station reception information from a satellite;
a first calculator configured or programmed to derive base station error information for each of the plurality of base stations based on the base station reception information for each of the plurality of base stations and base station coordinates for each of the plurality of base stations;
a storage to store a variation characteristic indicating a relationship between a first change amount, which is a change amount of the base station error information accompanied by a lapse of time, and an occurrence of a positioning abnormality at a predetermined position; and
a second calculator configured or programmed to derive predicted abnormality information to predict an occurrence of the positioning abnormality based on the base station error information and the variation characteristic.

2. The prediction system according to claim 1, wherein the base station reception information includes at least a pseudo-distance and a carrier phase.

3. The prediction system according to claim 1, wherein the base station error information includes at least one of an ionospheric delay error or a tropospheric delay error in the plurality of base stations.

4. The prediction system according to claim 1, wherein the variation characteristic includes a past record indicating a relationship between information of the first change amount at a base station position of each of the plurality of base stations and an occurrence of the positioning abnormality in a predetermined period and a predetermined time zone.

5. The prediction system according to claim 1, wherein the second calculator is configured or programmed to derive predicted abnormality information that the positioning abnormality will occur when a base station position of the base station in which the first change amount exceeds a predetermined reference approaches the predetermined position.

6. The prediction system according to claim 1, further comprising:
a mobile station to receive mobile station reception information from a satellite;
a third calculator configured or programmed to derive positioning information of the mobile station based on the base station reception information and the mobile station reception information; wherein
the predetermined position is the positioning information;
the first calculator is configured or programmed to derive the base station error information and mobile station error information of the mobile station based on the base station reception information, the base station coordinates, the mobile station reception information, and the positioning information;
the variation characteristic indicates a relationship among the first change amount, a second change amount that is a change amount of the mobile station error information accompanied by a lapse of time, and an occurrence of a positioning abnormality in the positioning information; and
the second calculator is configured or programmed to derive the predicted abnormality information based on the base station error information, the mobile station error information, and the variation characteristic.

7. The prediction system according to claim 6, wherein the mobile station reception information includes at least a pseudo-distance and a carrier phase.

8. The prediction system according to claim 7, further comprising:
a fourth calculator configured or programmed to derive RTK correction information based on the base station reception information; wherein
the third calculator is configured or programmed to derive the positioning information based on the RTK correction information and the mobile station reception information.

9. The prediction system according to claim 6, wherein the mobile station error information includes at least one of an ionospheric delay error or a tropospheric delay error in the mobile station.

10. The prediction system according to claim 6, wherein the second calculator derives predicted abnormality information that the positioning abnormality will occur when a difference between the first change amount of any one of the plurality of base stations and the second change amount exceeds a predetermined reference.

11. The prediction system according to claim 6, further comprising a fifth calculator configured or programmed to derive predicted base station information to predict the base station having the base station error information having a small difference from the mobile station error information based on the base station error information, the mobile station error information, and the variation characteristic.

12. The prediction system according to claim 11, wherein the third calculator is configured or programmed to derive the positioning information based on the base station reception information of the base station predicted by the predicted base station information and the mobile station reception information.

13. The prediction system according to claim 6, wherein the mobile station includes a sixth calculator configured or programmed to identify a position of the mobile station by dead reckoning.

14. A method to predict an occurrence of a positioning abnormality, the method comprising:
a first reception step of receiving base station reception information from a satellite in a plurality of base stations;
an error information deriving step of deriving base station error information for each of the plurality of base stations based on the base station reception information for each of the plurality of base stations and base station coordinates for each of the plurality of base stations; and
a prediction step of predicting an occurrence of the positioning abnormality based on a variation characteristic indicating a relationship between a first change amount, which is a change amount of the base station error information accompanied by a lapse of time, and an occurrence of a positioning abnormality at a predetermined position.

15. The method to predict an occurrence of a positioning abnormality according to claim 14, the method comprising:
a second reception step of receiving mobile station reception information from a satellite in a mobile station; and
a positioning step of deriving positioning information of the mobile station based on the base station reception information and the mobile station reception information; wherein
the predetermined position is the positioning information;
the error information deriving step includes a step of deriving the base station error information and mobile station error information of the mobile station based on the base station reception information, the base station coordinates, the mobile station reception information, and the positioning information;
the variation characteristic indicates a relationship among the first change amount, a second change amount that is a change amount of the mobile station error information accompanied by a lapse of time, and an occurrence of a positioning abnormality in the positioning information; and
the prediction step includes predicting an occurrence of the positioning abnormality based on the base station error information, the mobile station reception information, and the variation characteristic.
